(19) United States
(12) Patent Application Publication
(10) Pub. No.: US 2017/0076899 A1
(43) Pub. Date: Mar. 16, 2017

(54) SELF-RESETTING POWER BREAKER

(71) Applicant: BOISE STATE UNIVERSITY, Boise, ID (US)

(72) Inventor: Peter MULLNER, Boise, ID (US)

(21) Appl. No.: 15/266,449

(22) Filed: Sep. 15, 2016

Related U.S. Application Data
(60) Provisional application No. 62/218,685, filed on Sep. 15, 2015.

(51) Int. Cl. H01H 71/68; H01H 61/01

(52) U.S. Cl. CPC H01H 71/685; H01H 61/0107; H01H 2300/034; H01H 2071/665

(57) ABSTRACT

A system includes a first electrically conductive electrode and a second electrically conductive electrode. The system further includes a magnetic field source. The system also includes a magnetic shape memory (MSM) alloy positioned within a magnetic field of the magnetic field source with a portion of the MSM alloy being coupled with the first electrically conductive electrode. The magnetic field causes the MSM alloy to bend to contact the second electrically conductive electrode when the MSM alloy is in a first state. The magnetic field has no or negligible effect on the MSM alloy when the MSM alloy is in a second state.

### CROSS-REFERENCE TO RELATED APPLICATIONS

This application claims the benefit of U.S. Provisional Patent Application Ser. No. 62/218,685 filed on Sep. 15, 2015, and entitled “Self-Resetting Power Breaker,” the contents of which are hereby incorporated by reference in their entirety.

### GOVERNMENT LICENSE RIGHTS

This invention was made with government support under contract/grant number DMR-1207192 awarded by the National Science Foundation. The government has certain rights in the invention.

### FIELD OF THE DISCLOSURE

This disclosure relates generally to a self-resetting power breaker and more specifically toward a self-resetting power breaker that disconnects an electrical circuit upon electrical overload and reconnects the circuit after a short period.

### BACKGROUND

Power breakers can prevent circuits from overloading due to excess current by breaking a circuit when a threshold current is reached. For example, in a fuse, electrical current may heat a conductive thread thereby causing a breakdown (e.g., melting the thread) resulting in a circuit disconnecting. Likewise, a circuit breaker switch may detect large currents and may respond by opening a switch, thereby disconnecting the circuit.

Typical power breaker systems and methods may require human intervention to reconnect the circuit. For example, in order to reestablish the circuit using a fuse, the fuse must be replaced. In order to reestablish the circuit using a breaker switch, the switch typically must be switched back manually. In other examples, complex circuitry including active devices, such as transistors, relays, amplifiers, etc., may be used to reconnect a broken circuit. In these examples, an independent source of power may be necessary in order to power the circuitry to reset the breaker. Other disadvantages may exist.

### SUMMARY

Described herein is a power breaker that substantially solves, reduces, or eliminates at least one of the above-noted drawbacks of existing devices. An advantage of the self-resetting power breaker disclosed herein is that it resets itself without human action and without consuming power. Further, the self-resetting power breaker is scalable for use in a wide range of applications including, for example, high power electrical breakers at power stations, household power breakers, electronics, such as mobile phones and other mobile devices, and integrated circuits.

In an embodiment, a system includes a first electrically conductive electrode and a second electrically conductive electrode. The system further includes a magnetic field source. The system also includes a magnetic shape memory (MSM) alloy positioned within a magnetic field of the magnetic field source. A portion of the MSM alloy is coupled to the first electrically conductive electrode. The magnetic field causes the MSM alloy to bend to contact the second electrically conductive electrode when the MSM alloy is in a first state. The magnetic field has no or negligible effect on the MSM alloy when the MSM alloy is in a second state.

In some embodiments, the first state is a martensite state and the second state is an austenite state. In some embodiments, the system also includes a third electrically conductive electrode. The MSM alloy unbends to contact the third electrically conductive electrode when in the second state. In some embodiments, the MSM alloy includes a nickel-manganese-gallium (Ni-Ma-Ga) alloy. In some embodiments, the system includes a cooling block coupled to the MSM alloy. In some embodiments, the cooling block is actively cooled. In some embodiments, the magnetic field source includes a permanent magnet, an electronically generated magnet, or a combination thereof.

In an embodiment, a method includes initiating contact between a MSM alloy that is coupled to a first electrically conductive electrode and a second electrically conductive electrode when the MSM alloy is in a first state. The MSM alloy is coupled to a first electrically conductive electrode. The method further includes initiating separation between the MSM alloy and the second electrically conductive electrode by changing the MSM alloy from the first state to a second state using current induced heating through the MSM alloy. The method may further include reinitiating contact between the magnetic shape memory alloy and the second electrically conductive electrode by allowing the magnetic shape memory alloy to return to the first state through cooling.

In some embodiments, the first state is a martensite state and the second state is an austenite state. In some embodiments, the method further includes initiating contact between the magnetic shape memory alloy and a third electrically conductive electrode when the magnetic shape memory alloy is in the second state. In some embodiments, the magnetic shape memory alloy includes a nickel-manganese-gallium (Ni-Ma-Ga) alloy. In some embodiments, the method also includes actively cooling the magnetic shape memory alloy.

In an embodiment, a method includes forming a first electrically conductive electrode on a support. The method further includes forming a second electrically conductive electrode on the support. The method also includes connecting a magnetic field source to the support. The method includes positioning a MSM alloy positioned within a magnetic field of the magnetic field source. A portion of the magnetic shape memory alloy is coupled with the first electrically conductive electrode. The magnetic field causes the MSM alloy to bend to contact the second electrically conductive electrode when in a first state. The magnetic field has no or negligible effect on the MSM alloy when in a second state.

In some embodiments, the first state is a martensite state and the second state is an austenite state. In some embodiments, the method further includes forming a third electrically conductive electrode. The magnetic shape memory alloy unbends to contact the third electrically conductive electrode when in the second state. In some embodiments, the magnetic shape memory alloy includes a nickel-manganese-gallium (Ni-Ma-Ga) alloy. In some embodiments, the method also includes attaching a cooling block to the magnetic shape memory alloy. In some embodiments, the cooling block is actively cooled. In some embodiments, the magnetic field source includes a permanent magnet, an electronically generated magnet, or a combination thereof.

### BRIEF DESCRIPTION OF THE DRAWINGS

FIG. 1A is a diagram depicting an embodiment of a breaker switch system in a first state.

FIG. 1B is a diagram depicting the embodiment of the breaker switch system in second state.

FIG. 2A is a diagram depicting an embodiment of a breaker switch system that includes multiple switching electrodes in a first switch state.

FIG. 2B is a diagram depicting the embodiment of the breaker switch system that includes multiple switching electrodes in a second switch state.

FIG. 3A is a diagram depicting a-c and c-a oriented twinning in a uniformly distributed MSM alloy being in a first state.

FIG. 3B is a diagram depicting a-c and c-a oriented twinning in the uniformly distributed MSM alloy being in a second state.

FIG. 3C is a diagram depicting a-c and c-a oriented twinning in a non-uniformly distributed MSM alloy resulting in bending.

FIG. 3D is a diagram depicting a-c and c-a oriented twinning in semi-uniformly distributed MSM alloy resulting in a shallow curve.

FIG. 4A is an image depicting an MSM filament in a martensite state.

FIG. 4B is an image depicting the MSM filament in an austenite state.

FIG. 5 is a chart depicting transition temperatures of an MSM alloy from a martensite state to an austenite state and from ferromagnetic to paramagnetic.

FIG. 6 is a diagram depicting an embodiment of a breaker switch system including a cooling block.

FIG. 7 is a diagram depicting an embodiment of a method for breaking an electrical circuit.

FIG. 8 is diagram depicting an embodiment of a method for forming a breaker switch system.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the disclosure as understood by persons of skill in the relevant art.

### DETAILED DESCRIPTION

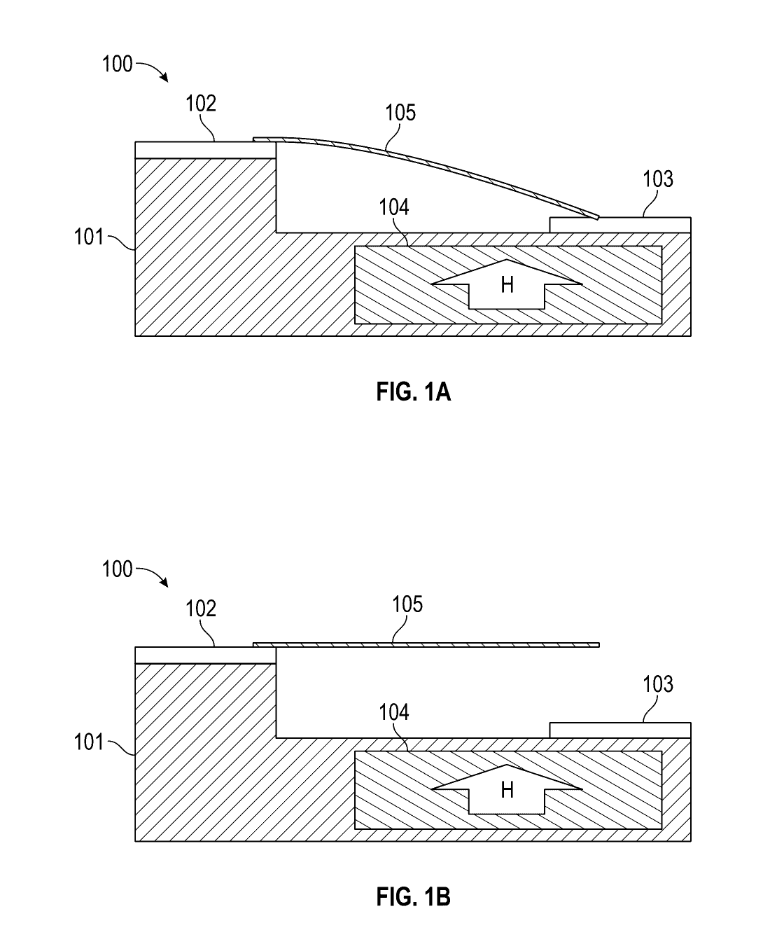

Referring to FIG. 1A, an embodiment of a breaker switch system 100 is depicted. The system 100 may include a base 101, a first electrode 102, a second electrode 103, a magnetic field source 104, and a MSM alloy 105.

The base 101 may include any structure sufficient to support and hold the electrodes 102, 103, the magnetic field source 104, and the MSM alloy 105 in position, as described herein. The magnetic field source 104 may create a magnetic field component substantially perpendicular to the MSM alloy 105. In another embodiment, the magnetic field source 104 may create a magnetic field component substantially parallel to the MSM alloy 105. The base 101 may be non-conductive, or semi-conductive, and may be resistant to electrical-current-induced heat produced at the MSM alloy 105 as described herein. In some embodiments (which may be scaled for use in a high-power circuit), the base may include shaped plastic, fiberglass, another type of insulator, or combinations thereof. In some embodiments (which may be scaled for use in a semiconductor, or on-chip, device), the base may include a device substrate, a dielectric, another layer of a semiconductor device, or combinations thereof.

The first electrode 102 and the second electrode 103 may be separated from each other such that electrical current cannot pass directly between them without passing through an intermediate structure (e.g., the MSM alloy 105). An actual distance between the electrodes 102, 103 may depend on many factors including, an intended operating power level of the system 100, a gauge of the electrodes 102, 103, another factor affecting the electrical properties of the system 100, or combinations thereof. The first electrode 102 and the second electrode 103 may include a conductive material.

The magnetic field source 104 may be positioned in proximity to the MSM alloy 105. The term in proximity as used herein means that a magnetic field of significant magnitude is applied to the MSM alloy 105 by the magnetic field source. The magnetic field source 105 may include a permanent magnet, an electronically generated magnet, another type of magnetic field generator, or combinations thereof.

The MSM alloy 105 may be rigidly attached to the first electrode 102 and, as described further herein, the MSM alloy 105 may be in a martensite state or an austenite state. Due to twinning within the structure of the MSM alloy 105, the MSM alloy may bend significantly in the presence of a magnetic field while in the martensite state. The bending may cause the MSM alloy 105 to make contact with the second electrode 103. The alloy composition of the MSM alloy 105 may be chosen such that at service temperature (which might be room temperature or another temperature, depending on specific applications), the MSM is in the martensite state. In some embodiments, the MSM alloy 105 may include a nickel-manganese-gallium (Ni-Ma-Ga) alloy. The MSM alloy 105 may be formed into a beam with dimensions that enable the MSM alloy 105 to carry a regular operating electrical current without substantial heating.

During operation, a magnetic field produced by the magnetic field source 104 may induce a torque on the MSM alloy 105. While in the low temperature martensite state, the MSM alloy 105 may bend due to twinning, thereby closing an electrical path between the electrodes 102, 103.

Referring to FIG. 1B, upon a power surge or an electrical current overload, the MSM alloy 105 may heat up due to Joule heating and may change states from the martensite state to the austenite state. In the austenite state, bending due to the twinning is less significant. The MSM alloy 105 may straighten, thereby breaking the connection between the electrodes 102, 103. In that case, the circuit is open and current ceases to flow through the MSM alloy 105. Without current flowing through the MSM alloy 105, the temperature of the MSM alloy 105 may dissipate through conduction, through radiation, through convection, through some other heat transfer mechanism, or through combinations thereof. As the heat dissipates, the MSM alloy 105 may return to the martensite state and may again bend due to the presence of the magnetic field. The electrodes 102, 103 may automatically reconnect through the MSM alloy 105 as contact is reestablished.

A benefit of using the properties of the MSM alloy 105 to break and subsequently reconnect an electrical path between the electrodes 102, 103 is that as the MSM alloy 105 cools, the magnetic field will automatically cause the MSM alloy 105 to bend due to twinning. As such, the system 100 does not require human intervention, or additional circuitry to reconnect the circuit. Other benefits and advantages of the system 100 may be apparent to persons of ordinary skill in the art having the benefit of this disclosure.

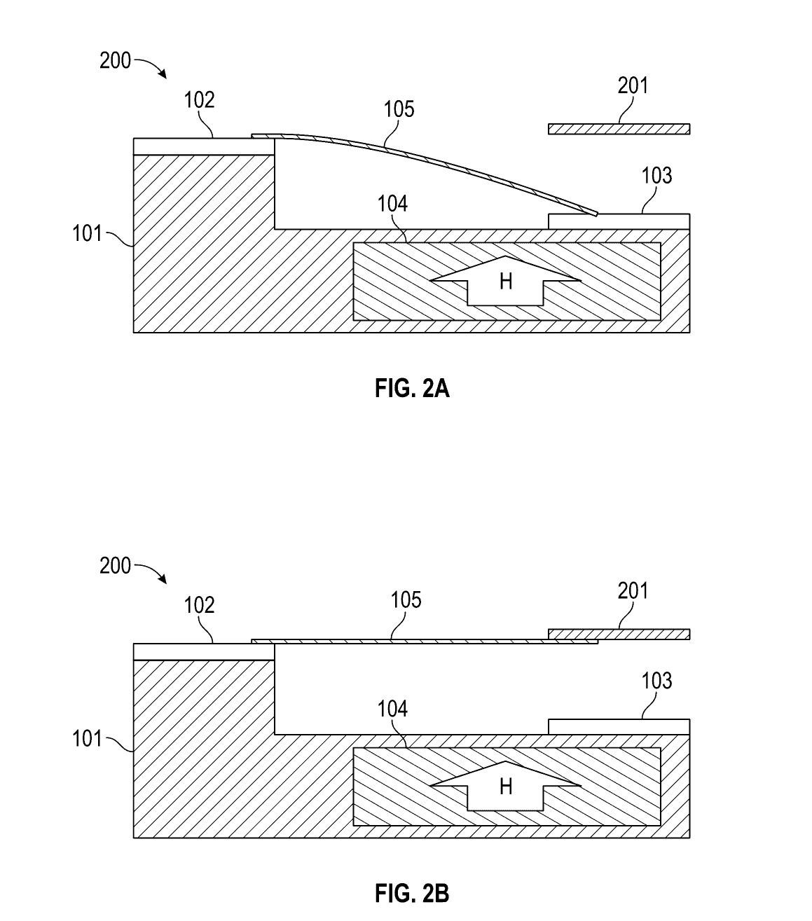

Referring to FIG. 2A, an embodiment of a switch system 200 is depicted. In addition to the base 101, the first electrode 102, the second electrode 103, the magnetic field source 104, and the MSM alloy 105, the system 200 may include a third electrode 201. While in the martensite state, the MSM alloy 105, under the influence of the magnetic field source 104, may bend to connect the first electrode 102 to the second electrode 103.

Referring to FIG. 2B, due to an electrical current, the MSM alloy 105 may heat up and change from the martensite state to the austenite state. In some cases, the electrical current may be higher than a normal operating current (e.g., an overload surge). As explained in further detail herein, while in the austenite state, the effect of twinning may decrease within the MSM alloy 105, thereby straightening it. While in the austenite state, the MSM alloy 105 may connect the first electrode 102 to the third electrode 201.

A benefit of including the third electrode 201 is that an alternate circuit may be powered after the circuit associated with the second electrode 103 is broken. For example, in some embodiments, the alternate circuit may be used to actively cool the MSM alloy 105 as described herein. Other benefits and advantages of the system 200 may be apparent to persons of ordinary skill in the art having the benefit of this disclosure.

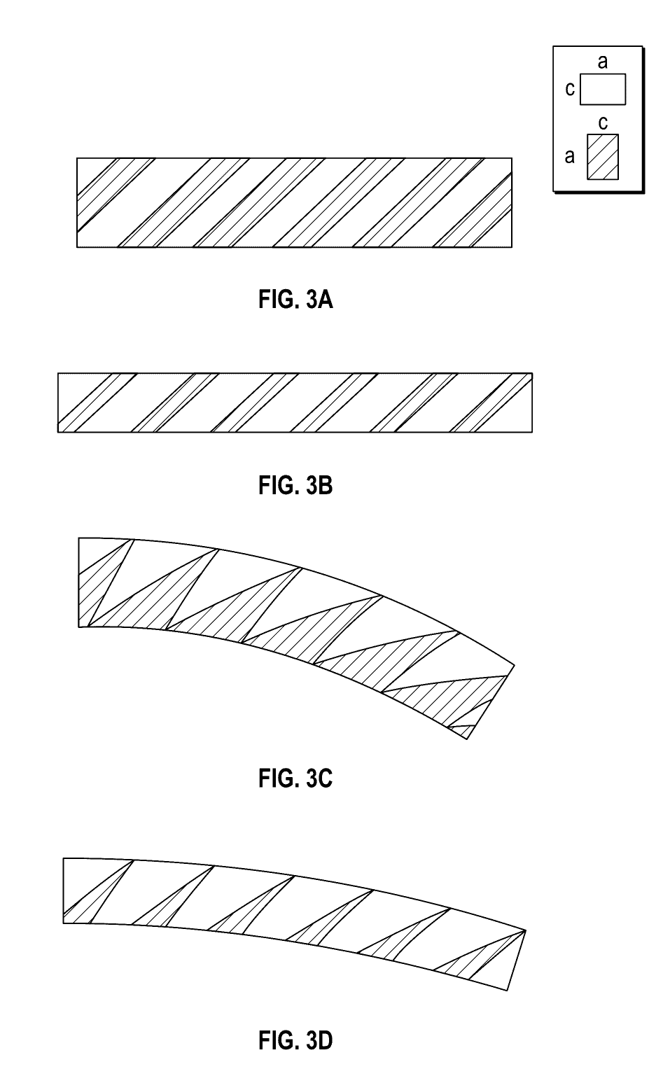

Referring to FIGS. 3A-3D, an MSM alloy exists in a high-symmetry, high temperature state call austenite and in a low-symmetry, low temperature state called martensite. In the martensite state, the MSM alloy deforms at low stress levels via a twinning process, which can be actuated with a magnetic field. The deformation may be called an MSM effect. As depicted in FIG. 3A, an MSM alloy may have an evenly spaced twinning structure. As a magnetic field is applied, the MSM alloy may extend due to the MSM effect as depicted in FIG. 3B.

Twinning in the martensite state may also lead to axial straining and enables strong bending. As depicted in FIG. 3C, when the twinning structure is uneven (for example, when a-c oriented portions of the MSM alloy are more prominent near a top surface of the MSM alloy and c-a oriented portions are more prominent near a lower surface of the MSM alloy, as depicted in FIG. 3C) the MSM effect may cause axial straining and the MSM alloy may bend. The extent of the bending may be tuned by increasing the volume of a-c oriented portions on the lower surface, as depicted in FIG. 3D.

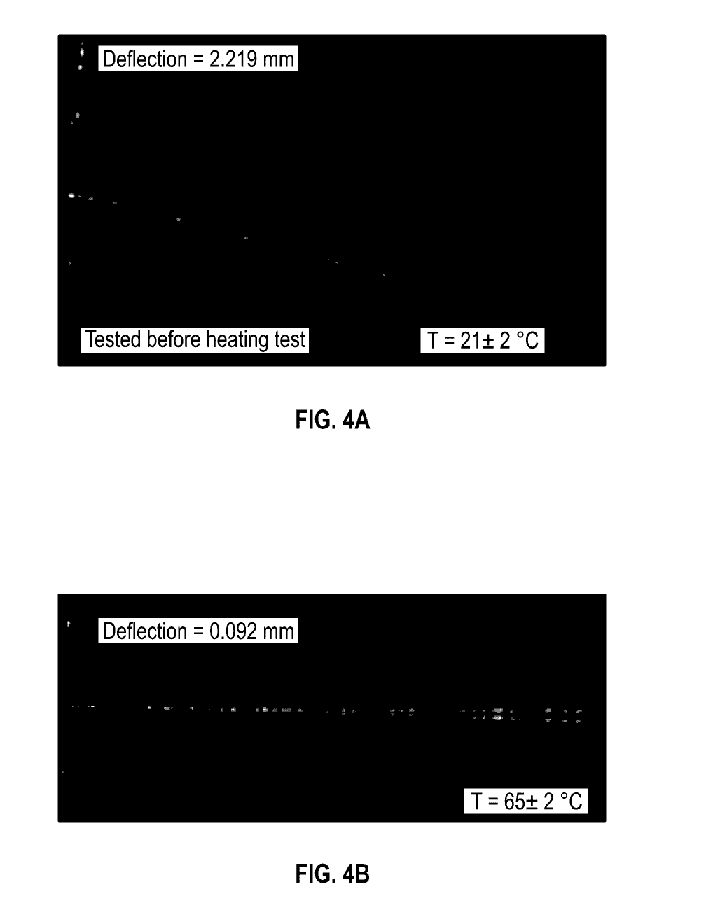

Referring to FIG. 4A and FIG. 4B, the common MSM effect produces axial deformation or axial straining (magnetic-field-induced straining, MFIS), which has been studied in great detail. Magnetic-torque-induced bending (MTIB) is introduced herein. MTIB is strong in the martensite phase, very small in the austenite phase, and absent above the Curie temperature. FIG. 4A depicts an example of MTIB for a Ni-Mn-Ga MSM alloy microwire at 21 ° C. where the wire is in the martensite phase. FIG. 4A is an image of the filament in the presence of a magnetic field, superimposed with an image of the filament without the presence of the magnetic field. FIG. 4B depicts the same filament at 65° C. where the wire is in the austenite phase.

The alloy composition of the MSM beam may be chosen such that at service temperature (which might be room temperature or another temperature), the MSM beam is in the martensite state. The magnetic field H induces a torque on the MSM beam which bends by twinning. At a temperature above the martensitic transition (where the MSM beam is in its austenite phase) the MSM beam is substantially straight.

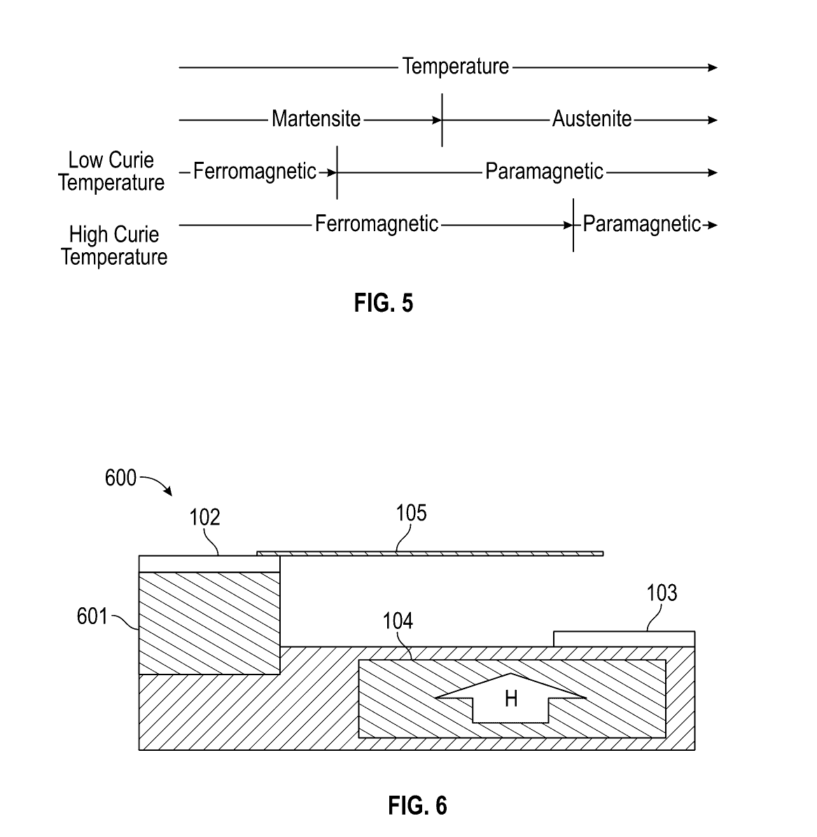

Referring to FIG. 5, the transition of the MSM alloy 105 from a martensite state to an austenite state as temperature increases is depicted. In some cases it may be beneficial for the MSM alloy 105 to be paramagnetic during the transition. For example, additives may be added to the MSM alloy 105 to produce a low Curie temperature. As used herein, a low Curie temperature is a Curie temperature that is below the martensite-to-austenite transition temperature. As depicted in FIG. 5, an MSM alloy with a low Curie temperature may fall into either a ferromagnetic-martensite state, a paramagnetic-martensite state, or a paramagnetic-austenite state. This may reduce the ferromagnetic effect of the magnetic field on the MSM alloy 105 during the transition. An MSM alloy 105 with a high Curie temperature may fall into either a ferromagnetic-martensite state, a ferromagnetic austenite state, or a paramagnetic austenite state.

By adjusting the composition of the MSM alloy 105, it can be made to enter different states at different temperatures, thereby controlling the effect a magnetic field will have on the MSM alloy 105. In some embodiments, the multiple states may be used to create a tri-state switch. Other benefits and advantages may be apparent to persons of ordinary skill in the art having the benefit of this disclosure.

Referring to FIG. 6, an embodiment of a breaker switch system 600 is depicted. In addition to the base 101, the first electrode 102, the second electrode 103, the magnetic field source 104, and the MSM alloy 105, the system 600 may include a cooling block 601. The cooling block 601 may include a conducting cold mass or a heat sink. In some embodiments, the cooling block 601 may be actively cooled (e.g., via cooling fan, liquid cooling, refrigeration, etc.).

A benefit of including the cooling block 601 in the system 600 is that the time taken to cool the MSM alloy 105 may be decreased. By selecting a predetermined capacity of the cooling block 601, the time taken by the system 600 to reconnect the electrodes 102, 103 through the MSM alloy 105 may be adjusted or otherwise tuned. Other benefits and advantages of the system 600 may be apparent to persons of ordinary skill in the relevant art having the benefit of this disclosure.

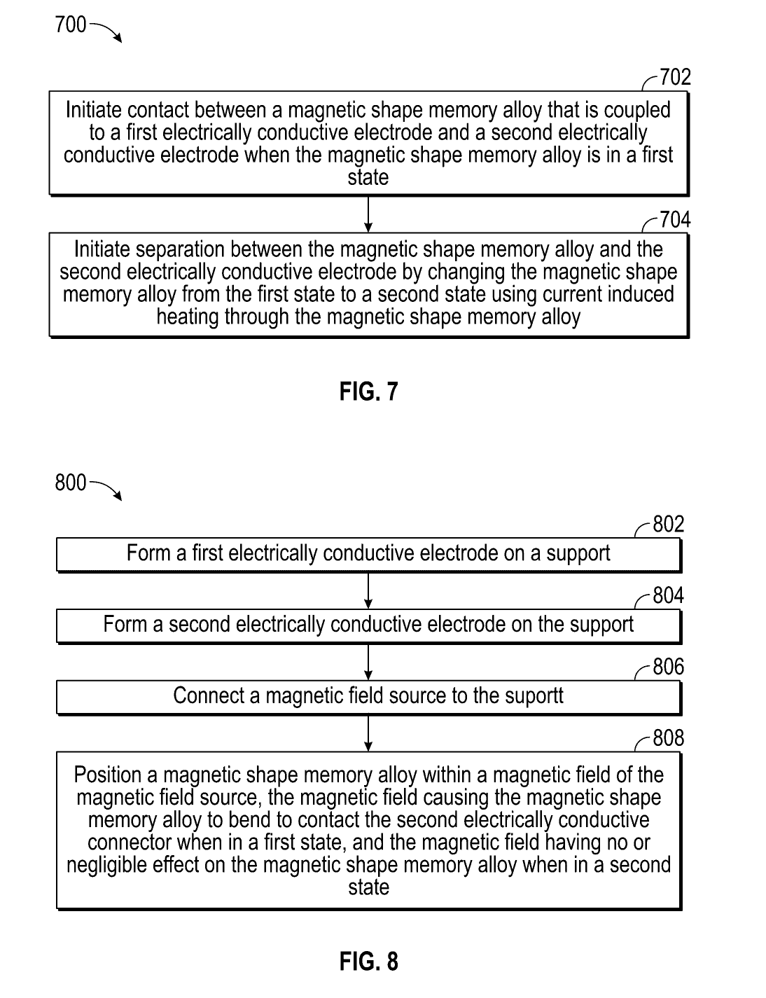

Referring to FIG. 7, an embodiment of a method 700 for breaking an electrical circuit is depicted. The method 700 may include initiating contact between a MSM alloy that is coupled to a first electrically conductive electrode and a second electrically conductive electrode when the MSM alloy is in a first state, at 702. For example, the MSM alloy 105 may be coupled to the electrode 102. As described herein, while the MSM alloy 105 is in the martensite state, contact may be initiated between the MSM alloy 105 and the second electrode 103.

The method 700 may further include initiating separation between the MSM alloy and the second electrically conductive electrode by changing the MSM alloy from the first state to a second state using current induced heating through the MSM alloy, at 704. For example, an electrical current through the MSM alloy 105 may increase a temperature and cause the MSM alloy 105 to change from the martensite state to an austenite state. While in the austenite state, the MSM alloy 105 may straighten, separating the MSM alloy 105 and the second electrode 103.

A benefit of the method 700 is that without additional circuitry, a circuit may be broken by separating the MSM alloy 105 and the second electrode 103. Further, the circuit may be reconnected automatically as the MSM alloy 105 cools and returns to the martensite state. Other benefits and advantages of the method 700 may be apparent to persons of skill in the relevant art having the benefit of this disclosure.

Referring to FIG. 8, an embodiment of a method 800 for forming a breaker switch system is depicted. The method 800 may include forming a first electrically conductive electrode on a support, at 802. For example, the first electrode 102 may be formed on the base 101.

The method 800 may further include forming a second electrically conductive electrode on the support, at 804. For example, the second electrode 103 may be formed on the base 101.

The method 800 may also include connecting a magnetic field source to the support. For example, the magnetic field source 104 may be connected to the base 101.

The method 800 may include positioning a MSM alloy within a magnetic field of the magnetic field source, the magnetic field causing the MSM alloy to bend to contact the second electrically conductive electrode when in a first state, and the magnetic field having no or negligible effect on the MSM alloy when in a second state. For example, the MSM alloy 105 may be positioned within a magnetic field of the magnetic field source 104 with the MSM alloy 105 bending to contact the first electrode 103 when in a martensite state and straightening while in an austenite state.

A benefit of the method 800 is that a system may be formed that breaks and automatically reconnects a circuit in response to a high level of current. Other benefits and advantages of the method 800 may be apparent to persons of skill in the relevant art having the benefit of this disclosure.

Although various embodiments have been shown and described, the present disclosure is not so limited and will be understood to include all such modifications and variations as would be apparent to one skilled in the art.

What is claimed is:

1. A system comprising:
a first electrically conductive electrode;
a second electrically conductive electrode;
a magnetic field source; and
a magnetic shape memory alloy positioned within a magnetic field of the magnetic field source, a portion of the magnetic shape memory alloy coupled to the first electrically conductive electrode and the magnetic field causing the magnetic shape memory alloy to bend to contact the second electrically conductive electrode when the magnetic shape memory alloy is in a first state, and the magnetic field having no or negligible effect on the magnetic shape memory alloy when the magnetic shape memory alloy is in a second state.

2. The system of claim 1, wherein the first state is a martensite state and the second state is an austenite state.

3. The system of claim 1, further comprising:
a third electrically conductive electrode, wherein the magnetic shape memory alloy unbends to contact the third electrically conductive electrode when in the second state.

4. The system of claim 1, wherein the magnetic shape memory alloy includes a nickel-manganese-gallium (Ni-Ma-Ga) alloy.

5. The system of claim 1, further comprising:
a cooling block coupled to the magnetic shape memory alloy.

6. The system of claim 5, wherein the cooling block is actively cooled.

7. The system of claim 1, wherein the magnetic field source includes a permanent magnet, an electronically generated magnet, or a combination thereof.

8. A method comprising:
initiating contact between a magnetic shape memory alloy and a second electrically conductive electrode when the magnetic shape memory alloy is in a first state, the magnetic shape memory alloy being coupled to a first electrically conductive electrode; and
initiating separation between the magnetic shape memory alloy and the second electrically conductive electrode by changing the magnetic shape memory alloy from the first state to a second state using current induced heating through the magnetic shape memory alloy.

9. The method of claim 8, further comprising reinitiating contact between the magnetic shape memory alloy and the second electrically conductive electrode by allowing the magnetic shape memory alloy to return to the first state through cooling.

10. The method of claim 8, wherein the first state is a martensite state and the second state is an austenite state.

11. The method of claim 8, further comprising:
initiating contact between the magnetic shape memory alloy and a third electrically conductive electrode when the magnetic shape memory alloy is in the second state.

12. The method of claim 8, wherein the magnetic shape memory alloy includes a nickel-manganese-gallium (Ni-Ma-Ga) alloy.

13. The method of claim 8, further comprising actively cooling the magnetic shape memory alloy.

14. A method comprising:
forming a first electrically conductive electrode on a support;
forming a second electrically conductive electrode on the support;
connecting a magnetic field source to the support;
positioning a magnetic shape memory alloy within a magnetic field of the magnetic field source, a portion of the magnetic shape memory alloy being coupled with the first electrically conductive electrode and the magnetic field causing the magnetic shape memory alloy to bend to contact the second electrically conductive electrode when in a first state, and the magnetic field having no or negligible effect on the magnetic shape memory alloy when in a second state.

15. The method of claim 14, wherein the first state is a martensite state and the second state is an austenite state.

16. The method of claim 14, further comprising:
forming a third electrically conductive electrode, wherein the magnetic shape memory alloy unbends to contact the third electrically conductive electrode when in the second state.

17. The method of claim 14, wherein the magnetic shape memory alloy includes a nickel-manganese-gallium (Ni-Ma-Ga) alloy.

18. The method of claim 14, further comprising:
attaching a cooling block to the magnetic shape memory alloy.

19. The method of claim 18, wherein the cooling block is actively cooled.

20. The method of claim 14, wherein the magnetic field source includes a permanent magnet, an electronically generated magnet, or a combination thereof.
